(19) United States
(12) Patent Application Publication
(10) Pub. No.: US 2017/0195835 A1
(43) Pub. Date: Jul. 6, 2017

(54) USER ALERTING

(71) Applicant: VODAFONE IP LICENSING LIMITED, London (GB)

(72) Inventors: Youssef CHAMI, London (GB); Sumera KHALANDAR, London (GB)

(21) Appl. No.: 15/314,479

(22) PCT Filed: May 27, 2015
(86) PCT No.: PCT/EP2015/061742

§ 371 Date: Nov. 28, 2016

(30) Foreign Application Priority Data
May 28, 2014 (GB) 1409486.6

(51) Int. Cl. H04W 4/02; H04W 28/02; H04L 12/14; H04W 4/14; H04L 12/26

(52) U.S. Cl. CPC H04W 4/021; H04W 4/14; H04L 43/12; H04L 12/1407; H04W 28/0284; H04W 28/0289

(57) ABSTRACT

User location-based alerting in a cellular network may be provided. Geographical location information for one or more mobile terminals of the cellular network is received at a network entity of the cellular network from one or both of: a core network part of the cellular network; and a network management part of the cellular network. One or more geographical locations are identified and a message is then generated to cause an alert to be sent to any mobile terminals in the one or more geographical locations based on the received geographical location information.

### TECHNICAL FIELD OF THE INVENTION

The invention concerns a network entity of a cellular network and a method for user alerting in a cellular network.

### BACKGROUND TO THE INVENTION

The Third Generation Partnership Project (3GPP) has been developing enhancements to cellular systems to allow their operation for public safety or emergency services (ES) communications. These are especially intended to work with the Long Term Evolution (LTE) architecture. Aims of this approach may include: reduced cost; improved functionality; and increased flexibility in comparison with existing public safety communication infrastructure, such as the Terrestrial Trunked Radio (TETRA) network.

The functionality of ES communications, as well as other types of communication service, is significantly enhanced by location determination and/or tracking of the User Equipment (UE) for a subscriber. For example, a key component in Public Safety and Emergency Services communication includes ascertaining precise location of disaster or relief site, saving time and lives. This information is important to disaster relief teams and public safety personnel in order to protect life and reduce property loss. It is highly desirable that such a system learns or collects all relevant location information, in near-real time.

Autonomous location determination methods, such as Global Positioning System (GPS) technology at a UE and Geographical Information Systems (GIS) offer precise location tracking and are considered an international industry standard, especially for use by emergency services. Search, rescue teams and Emergency services teams use a combination of these technologies and remote sensing technology to create maps of disaster areas for rescue and aid operations, as well as to assess damage. However, they are not always sufficient (for example, when the UE is deep indoors) and not always available, such as when they are regionally disabled.

A further use of location information is in the targeting alerting of users, in case of (planned and unplanned) events. The alerting may encompass mobiles on all technologies (for example, 2G, 3G and 4G) and all spectrum bands. This is currently achieved by searching a Mobile Switching Centre (MSC) or Visitor Location Register (VLR) database a list of UEs (with reference to their Mobile Subscriber Integrated Services Digital Network Number, MSISDN and/or their International mobile subscriber identity, IMSI) served by a specific base station or cell. A message is then input to an SMS gateway for a text message delivery for each of those mobile terminals. This process is long, taking about 45 min for a first delivery and subsequent retries add further delays. This delay is significant for a system in which UEs are mobile. The system is inefficient and users may be inconvenienced by communicating information about an area in which a UE was only briefly present. Ideally, the alert should be received within a few minutes of the event happening (for example, no more than 3 to 5 minutes). System reliability and effectiveness are desirably ensured at all times.

Cell Broadcast (CB) is an existing technology used to deliver messages to multiple users within a geographical area, which can be either a single cell-site or an entire network. A specific broadcast channel is required as well as provisioning on the devices. A CB Server sends messages over a designated channel and UEs must be configured to listen to (scan continuously) this channel or the message is lost. CB is an expensive, inefficient and inflexible solution and is gradually being phased out.

Alternatives are therefore needed that are: affordable (to avoid the network operator costs becoming unmanageable); real Time and efficient; enhanced in comparison to existing location positioning approaches; and flexible (to match and respond to user requirements better).

### SUMMARY OF THE INVENTION

Against this background, there is provided a network entity of a cellular network according to claim 1 and a method for user alerting in a cellular network in accordance with claim 15. The method of claim 15 may optionally be provided with any features disclosed in connection with the network entity of claim 1. A computer program in line with claim 16 is also provided.

This approach may provide network-based user location determination, tracking and alerting, which matches the requirements set out above. In particular, the determining, tracking or alerting may be based on one or more of:

a core-network monitoring probe that monitors the Mobile Management Entity (MME)—Home Subscriber Server (HSS) interface (S6a, for example) and/or the MME—Serving Gateway (SGW) or Packet Data Network Gateway (PGW) interface (S11); an interface with a Policy and Charging Rules Function (PCRF), such as a Gx interface; and an interface with an Operational Support System (OSS) or Network Management System (NMS).

The network entity may be a Location Service Centre and/or Alerting System in the cellular network. This may be in communication with a Location Manager, which may be of the cellular network or of a service provider. The cellular network may provide network connectivity, including lower layers of the networking protocol stack, for example one or more of: a physical layer; a link layer; a network layer; a transport layer; and a session later. The service provider may manage the higher layers of the protocol stack, which may comprise one or more of: a session layer; a presentation layer; and an application layer and typically comprises the user-plane traffic.

This may additionally support one or more of: emergency calling; UE-hosted position calculations; alternative positioning sources (such as WiFi access points); and roaming interoperability. These functions may be supported by the Location Service Centre and the SGi interface (for user plane) and Mobile Location Protocol (MLP) interfaces.

The network entity may be provided with: a target geographical location or cell information (which can act as an input or trigger); and network Information (so that information about users within one or more defined target locations may be collated in real time). Basic coverage may be provided using the cellular network or a WiFi network as a transport layer for collecting user locations or positions in the Network. Optionally, the system may offer interfaces to a system administrator and/or users to opt in or opt out of the service and set preferences for privacy concerns. Overload protection may advantageously be employed to prevent the network from being overloaded in one or more specific locations.

In another approach, an alert message may be sent to UEs in a given geographical area, such as for the purposes of emergency alerting. An alerting system (which may interfaced with a third party system) uses the determined location to cause alerts to be sent (particularly using SMS) to any UEs in that area. Delivery of the SMS to the affected UEs may be subject to congestion or throttle control, for example by predetermining a maximum number or a percentage of UEs to be alerted. The throttling mechanism may determine the order in which UE receive the alert, for instance prioritising UEs closer to a location. Further checking of the network interfaces may be used to determine if new users are found to have moved into the area. A cross-check to the list of UEs already having received the alert may be performed and the alert may be subsequently be sent to any outstanding UEs.

Further preferred features of the invention are set out in the accompanying claims and will further become apparent from a consideration of the following specific description of particularly preferred embodiments. Additional advantages will also be discussed below.

### BRIEF DESCRIPTION OF THE DRAWINGS

The invention may be put into practice in a number of ways, and some preferred embodiments will now be described by way of example only and with reference to the accompanying drawings, in which:

FIG. 1 illustrates a block diagram of an example architecture for a cellular network in accordance with a first embodiment;

FIG. 2 depicts a flow chart showing a process for operation of the cellular network in line with the architecture shown in FIG. 1;

FIG. 3 shows a block diagram of an example architecture for a cellular network in accordance with a second embodiment; and

FIG. 4 illustrates a flow chart showing a process for operation of the cellular network in line with the architecture shown in FIG. 3.

### DETAILED DESCRIPTION OF PREFERRED EMBODIMENTS

Although the invention will now be described with reference to two specific embodiments, these should not be considered mutually exclusive and indeed, the combination of the architectures and/or functionalities described may be possible. Indeed, the combination of any specific features described herein is provided, even where that combination is not explicitly discussed.

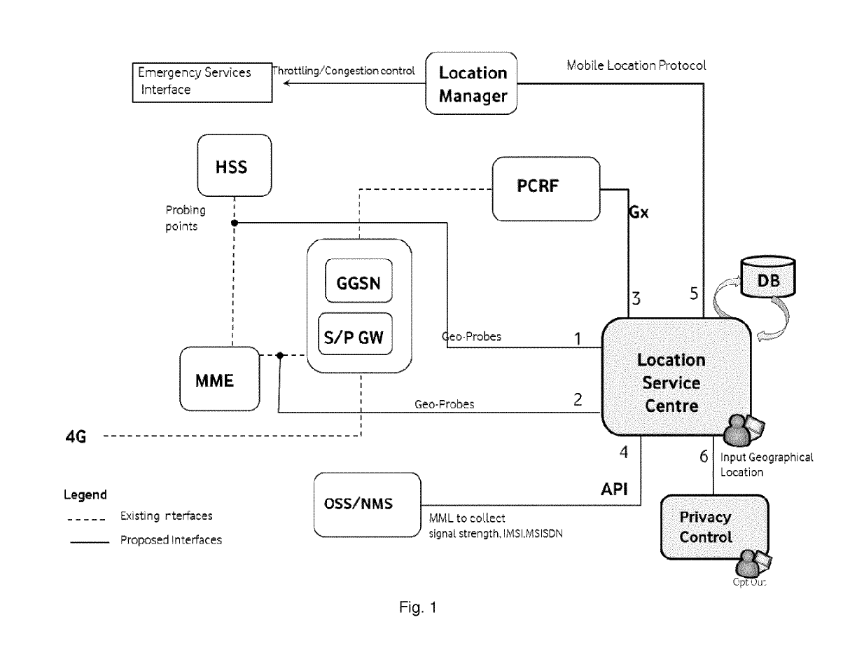

Referring first to FIG. 1, there is illustrated a block diagram of an example architecture for a cellular network in accordance with a first embodiment. A Location Service Centre is provided with a number of interfaces to mobile network infrastructure to collect identities and/or geographical locations.

Interfaces 1 and 2 received information at the Location Service Centre from Packet Core Network. Interface 3 is between the Location Service Centre and the Policy and Charging Rules Function (PCRF) and is a 3GPP-specified Gx interface. Interface 4 is an Application Programming Interface (API) for Operational Support System (OSS) or Network Management System (NMS) of the network. Then, interface 5 allows the Location Service Centre to receive requests and provide information to a Location Manager entity, which may be located in an external service provider network. A user interface 6 to input location information is also provided. It is possible to extend such a user portal for customisation and privacy control, as will be discussed below.

In general terms, the Location Service Centre or Alerting System (of another embodiment, discussed below) may be understood as a network entity of a cellular network, comprising: a location determining interface, configured to receive geographical location information for one or more mobile terminals of (and optionally in the cellular network from one or both of: a core network part of the cellular network; and a network management part of the cellular network; and action logic, configured to generate a message for communication from the network entity to another entity (within the cellular network or external to it) based on the received geographical location information. This uses network-based information to identify geographical location information for UEs in an efficient and fast way. In this embodiment, the action logic is configured for communication with the Location Manager over interface 5, for example, but it will be understood that other possibilities can be considered, as will be noted with reference to another embodiment.

This may also be considered as a method for user location determining in a cellular network, comprising: receiving, at a network entity of the cellular network, geographical location information for one or more mobile terminals of (and optionally in) the cellular network from one or both of: a core network part of the cellular network; and a network management part of the cellular network; and generating a message for communication from the network entity to another entity based on the received geographical location information. Whilst the features of the network entity are discussed herein, it will be understood that these features may also be provided as process steps of this method.

Even though the Location Service Centre is not connected to the Radio Access Network (RAN) or Core Network directly, congestion controls and throttling rates are provided across all the interfaces. Necessary alarms and performance metrics will notify a system administrator of any faults in the system.

Some of the specific interfaces will now be discussed. For example, the location determining interface may comprise an interface to at least one monitoring probe that is configured to monitor an interface between network entities of the core network part of the cellular network. The Location Service Centre may support direct feeds from monitoring probes without significant processing. As shown by black spots in FIG. 1, feeds may be provided from one or more monitoring probes (known as Geo probes) from Packet Core Network to gather user locations. Such probes have been previously employed in Packet Data Network for OSS or troubleshooting purposes. However, such feeds can be extended to the Location Service Centre over interface 1 using a probe deployed between an MME and an HSS and/or over interface 2 between SGW or PGW and MME to collect mobile identifiers within a given geographical area. When feeds from a HSS or HLR (Home Location Register) are available, the system considers only those mobile terminals (by reference to the IMSI and/or MSISDN) for which a successful or positive response from the HSS to connect requests have been received.

For a UE that has opted out of data services, a dedicated (private) APN will be provisioned with necessary settings in the network Billing systems to ignore charging. For instance, a least significant packet for the emergency location service may be employed. The private APN will serve the purpose of getting UEs under data services provision and therefore letting the network know about their location, even if they are idle.

Additionally or alternatively (to the monitoring probe functionality), the location determining interface may comprise an interface with a PCRF of the cellular network. This is shown as interface 3. The PCRF can inform the Location Service Centre about all the UEs attached in the network, including their cell-site details over a Gx Interface extended to the system.

In another approach, which may optionally be combined with the technology used over interfaces, 1, 2 or 3, the location determining interface comprises an interface with OSS/NMS of the cellular network. This interface can comprise request logic, configured to request the geographical location information for the one or more mobile terminals of the cellular network from the OSS or NMS. Advantageously, the interface with the OSS/NMS comprises an Application Programming Interface (API). The interface may further comprise location logic, configured to receive the geographical location information for the one or more mobile terminals from the OSS or NMS and to determine further geographical location information for the one or more mobile terminals based on the received geographical location information.

The API with the networks' central OSS/NMS can assist in collecting customer location information. The system can request CellID, IMSI, MSISDN and signal strength for each mobile terminal over the API using one or more Man-Machine Language (MML) commands. Any UE covered by two cell sites (base stations) is marked with the cell providing the best signal The API defines the language that each of the software modules of the platform use to communicate and optimise application delivery. The API may also facilitate the provision of CellID information externally from the Location Service Centre, for example to the service provider. The API may further allow communications from connected systems to update location details of newly registered customers in the area.

Where multiple approaches for network-based location determination are used, the information received from multiple approaches or interfaces can be combined, ranked or assigned priority in order to determine the location based on more than one source. The network entity may be configured to have a bias to use information from one interface over another. For instance, information over the API (interface 4) may be preferred where available over other sources such as the monitoring probes (interfaces 1 and 2), as this may provide controlled on-demand polling. Additionally or alternatively, a probe from a HLR or HSS (interface 1) may provide more accurate location information, as devices would perform frequent periodic updates within this part of the core network.

In embodiments, the network entity may further comprise a location database, configured to store geographical location information for the one or more mobile terminals of the cellular network based on the received geographical location information. This can be used to keep information about each UE and its geographical location, especially for those that are being tracked. Another possible advantage of a User Repository is the ability to exclude any emergency teams from receiving other broadcast messages that may be intended for regular (that is, not ES) users of the cellular network.

In any approach, the received geographical location information in respect of a mobile terminal may comprise one or more of: at least one identifier for the mobile terminal (such as an IMSI and/or MSISDN); an identifier for a base station of the cellular network serving the mobile terminal (for instance, CellID); and a link quality between the mobile terminal and one or more base stations of the cellular network (such as a signal strength or similar measurement). The location or position of a UE can be determined using Radio Signal Strength or another similar measurement. From signal strengths, the Location Service Centre may estimate the distance of a UE from an affected locations or cell or base station site nearest to an event or disaster, for instance.

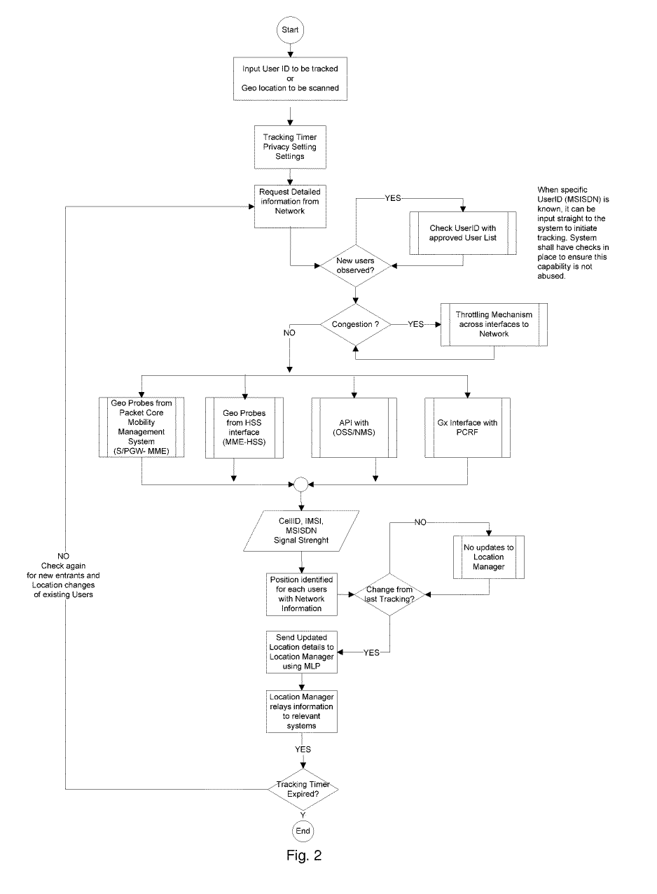

Referring next to FIG. 2, there is depicted a flow chart showing a process for operation of the cellular network in line with the architecture shown in FIG. 1. The input to the Location Service Centre may be one or more UE identifiers and/or one or more geographical locations.

A target location can be provided as an input to the Location Service Centre through a user interface and can then serve as an index to filter probe packets. The output will then be a list of all MSISDN/IMSI under a selected base station (CellId) connected to the packet core network. This may allow UEs to be located across an entire affected location. For instance, this could help to ascertain how many emergency personnel are present or deployed within a given location. In cases where multiple teams (for instance, fire and police) are working together, it would be convenient to search or sweep a given location for UEs and later track these UEs once identified.

When a target CellId input is received, the Location Service Centre would request a fresh relay of information about Emergency teams attached to the network for data Services. It will then identify these users by checking against a list of approved users. Privacy controls and system settings would be in place to manage the flow of information from/to these users from the rest of the Network.

Additionally or alternatively, the system could locate specific users within the network. This approach would work better when the identity and/or the location of the UEs is known previously, for example when the users are sent into the field for rescue or relief activities. An example of this use may be for personnel deployed in intense relief operations, such as in tsunami or wildfire events. Multiple agencies may be involved (resulting in the possibility of multiple service providers being used, although the network coverage may be provided by the same cellular network). The system may be used to carry out a sweep to search for all emergency services personnel in the area. A list of personnel (for instance with reference to their UE IMSI and/or MSISDN) would be provided to the system to allow their locations to be determined.

In general terms, this may be understood as the action logic being configured to receive a query message identifying query information (for example from the Location Manager over interface 5 or interface 6). The query information may comprise an indication of one or more mobile terminals and/or one or more geographical locations. Then, the message generated by the action logic may be a response message comprising an indication of one or more geographical locations and/or one or more mobile terminals corresponding with the query information. In other words, if the query information comprises an indication of one or more mobile terminals, the response may comprise an indication of one or more geographical locations for those mobile terminals and vice versa. The information in the response message is based on the received geographical location information.

If new UEs are observed, these can be checked against the approved user list, so that UEs not part of the service being tracked can be excluded. This can generally be understood as registration logic, configured to identify that the received geographical location information is for a mobile terminal that was previously unknown to the network entity. The registration logic may then check that the previously unknown mobile terminal is identified on an approved list. In that case, the action logic is preferably configured to generate the message based on the received geographical location information for the previously unknown mobile terminal in response to the registration logic confirming that the previously unknown mobile terminal is identified on an approved list.

If congestion is detected on any interfaces, throttling can be employed to mitigate this. Traffic control logic may be provided to detect congestion on one or more interfaces of the cellular network and to enable such throttling on the basis of the detection. In particular, while the Location Service Centre is tracking the location of one or more UEs (as discussed below), the transmission of queries or requests to the cellular network may be more frequent than normally required. It is therefore desirable that all interfaces towards the cellular network and Location Manager have a throttling mechanism to mitigate overloading.

Once the geographical location information is received from the network, a position may be identified. An update may be provided, especially if there is a change to any information. This may be considered as an optional feature of the action logic, which may be further configured to generate one or more follow-up messages subsequent to the response message. The one or more follow-up messages comprise one or more geographical locations and/or one or more mobile terminals corresponding with the query information. The one or more follow-up messages may be generated at a specific time (or times, for example at regular intervals) and/or in response to a change in the received geographical location information (for instance, when the location for a UE changes and/or the UEs in a geographical area change).

The Location Service Centre connect to Location manager over interface 5 using Mobile Location Protocol (MLP). This is a known application-level protocol for receiving the position of mobile terminals in a way that is independent of the underlying network technology. The Location Service Centre stores location information of specific users in a local database and can then forward this to Location Manager over interface 5. It can poll or check the network for updates or changes in location of emergency personnel and feed this back to the Location Manager.

Once user locations are identified, the Location Service Centre may track these across a given area for specified period of operation. For example, fire personnel working in wildfire areas may be identified by scanning for their MSISDN across all the Celli Ds in the specified areas. Once an exact cell location is identified, the Location Service manager can relay this information to Location Manager (over interface 5) which can display it on a user-friendly interface such as a map. The Location Service Centre can then check on their location again after specified interval, such as a number (say 5) minutes, and if the CellId has changed, it will communicate this back to the Location Manager.

The system supports Geographical Information System (GIS) or any other relevant system (such as based on a GUI) to display cell or base station information and/or UE locations on a map. As the system gathers location details from the cellular network, the map view can be used for operational purposes. Also, a system administrator can use this GUI to elect the region or area where Emergency Personnel are to be deployed.

Once users are located and ‘marked’ in the system, ‘tracking’ of the users can be carried out. The Location Service Centre can monitor their movement across location (for example, by cell site) and relay this information back to the Location Manager. A live image of tracked UEs moving about on a map view can therefore be provided, which can optimise co-ordination work and run precise relief and/or rescue missions.

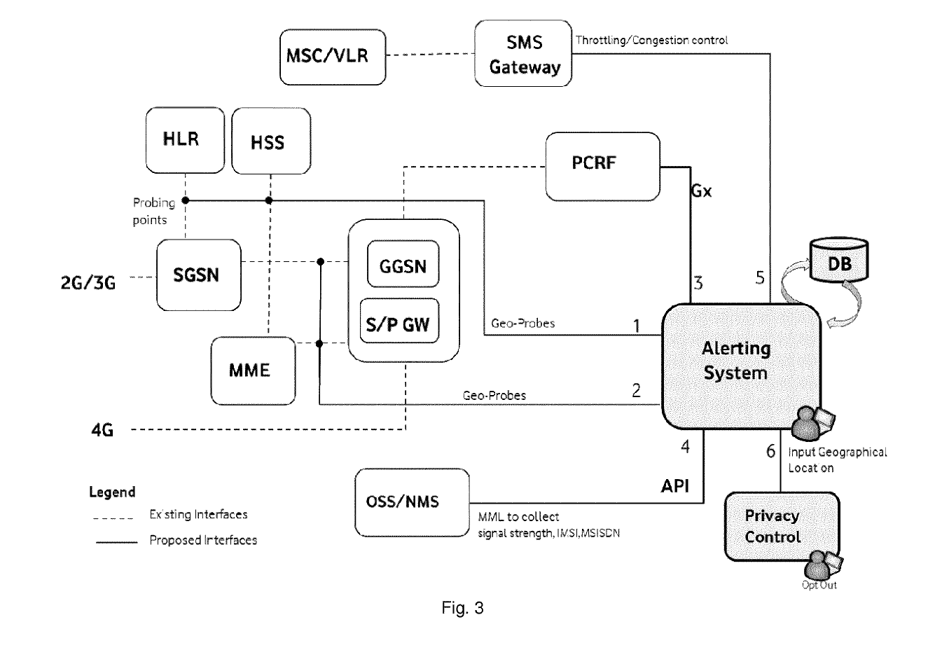

Referring next to FIG. 3, there is shown a block diagram of an example architecture for a cellular network in accordance with a second embodiment. This architecture is very similar to the first embodiment, except that the Location Service Centre is now termed an Alerting System. In many respects, these have similar or overlapping functionality and indeed, their functionality may be combined in many respects. For example, individual specific functionalities of the Location Service Centre or a combination of functionalities may also be applied to the Alerting System and vice versa. It should particular be noted that the interfaces of the Alerting System are shown as identical to the Location Service Centre and they may be used in the same way.

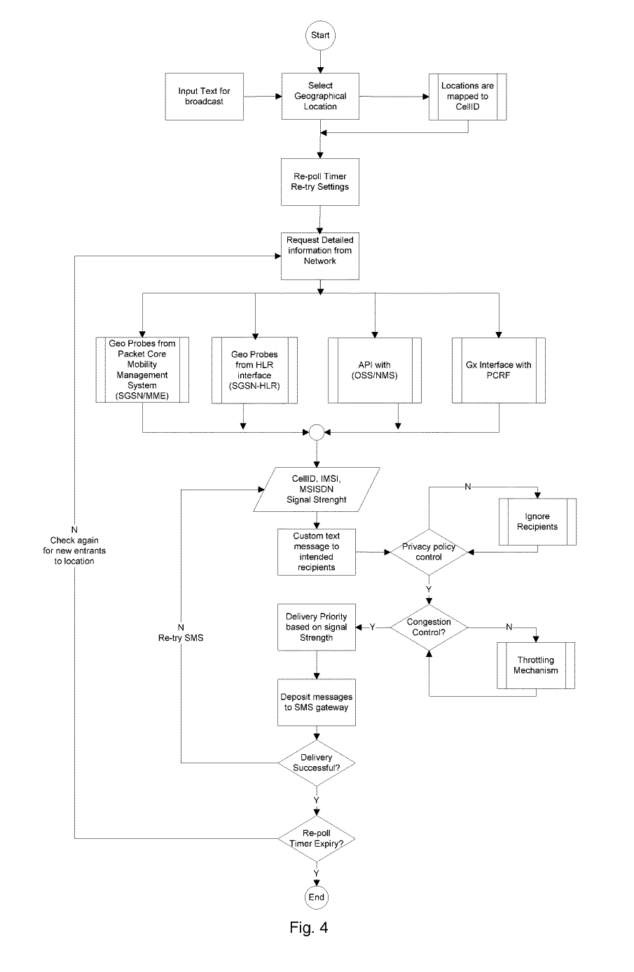

Referring now to FIG. 4, there is illustrated a flow chart showing a process for operation of the cellular network in line with the architecture shown in FIG. 3. Again, this process is similar to that shown in FIG. 2, although there are differences. In any event, any specific functionality shown in FIG. 2 can also be implemented in this process, and vice versa.

A system user inputs a geographical location and text for broadcast (which need not be delivered by a broadcast technology though), a mechanism is triggered to start data collection from defined sources in the network, as discussed above with reference to FIGS. 1 and 3.

Data from the monitoring probes is processed by the Alerting system using the CellId info as an index and custom messages are created. There is a provision to re-poll new customers entering the geographical area. Re-poll timers can allow the system to run a tracing request, comparing the ISMI of the UE identified in the cell in the alerting system database and subtracting any UEs already determined. A retry timer can define when any failed SMS messages are sent again to same UEs. Both these timers can be set up upon agreement with service providers or UE providers, considering existing situations like projected traffic post-event, nature or sensitivity of the event or similar issues.

More generally, it can be understood that the action logic is configured to receive (internally or externally) a request message identifying one or more geographical locations. Then, the message generated by the action logic may comprise at least one alert message, which advantageously causes an alert to be communicated to each of one or more mobile terminals in the identified one or more geographical locations, based on the received geographical location information.

The alert to be communicated preferably comprises a Short Messaging System (SMS) message. Additionally or alternatively, other messaging protocols, such as Unstructured Supplementary Services Data (USSD) may be used. The USSD approach is similar to SMS from the network perspective, but it results in a different experience to the subscriber. For example, the USSD message is directed to the screen of the UE, not an inbox. The USSD technology is internal to an operator network and therefore more secure than SMS and Cell Broadcast. USSD also allows dialogs between the UE and the emergency system. However, the system must gather the identities of the UEs in the targeted area to use USSD and this capability will create additional load on the network and take additional time to reach all users in targeted location or locations. SMS is the preferred option for emergency alerting as it is a point-to-point protocol and allows delivery to designated UEs. It is also generally ubiquitous in cellular networks. USSD delivery is also not as reliable as SMS, especially with the provision of receipt confirmation within the SMS functionality. Also, USSD messages cannot be forwarded or stored for review.

Delivery of the alert messages may be done in a number of different ways.

In a first approach, the most affected may be alerted first. Some interfaces, for example the API with OSS/NMS system (interface 4), can provide signal strength information. The system can estimate the distance from affected locations using this information. This may allow the system to use intelligence to prioritise delivery based on the proximity to a location, such as that of an event or disaster.

In a second methodology, a staggered approach may be adopted. This is volume-based and alerts are delivered in groups, based on fixed percentages of total affected UEs. This may avoid aggravating network conditions in affected areas. For instance, the first 10% may receive the alert within 5 minutes and another 20% after 10 minutes. These proportions and timings may be managed (set and/or adjusted) by a user (or users) and/or an administrator.

A third approach uses bulk delivery. The system can send alerts to all the customers at the same time at the discretion of the system administrator. It shall offer warning messages or seek explicit confirmation when attempting bulk delivery, as a safeguard against induced congestion.

In general terms, this may be understood that the at least one alert message causes the alert to be communicated to each of one or more mobile terminals in the identified one or more geographical locations at a time dependent on the received geographical location information.

Congestion control may be achieved by pre-determining a maximum number (or a percentage) of UEs to be alerted. The throttling mechanism may then determine the order in which UEs receive the alert, for example prioritising UE close to the site of the emergency, as discussed above.

The action logic is optionally further configured to determine whether the at least one alert message resulted in the alert being successfully communicated to each of one or more mobile terminals in the identified one or more geographical locations. The action logic may then be configured to generate a re-transmit message causing the alert to be communicated again to any one or more mobile terminals in the identified one or more geographical locations for which the alert was not successfully communicated. As noted above, a retry timer may be employed for this purpose.

The network entity may further comprise privacy logic, configured to detect any mobile terminals from the one or more mobile terminals in the identified one or more geographical locations that are on a privacy control list and to control the action logic not to cause an alert to any mobile terminals detected on the privacy control list.

A system combining the Location Service Centre or Alerting System (or equivalent functionality) with other parts of the network is also provided. Any combination of specific features shown in FIGS. 1 to 4 or as discussed herein may be configured accordingly.

Although specific embodiments have now been described, it will be recognised that a number of variations or modifications may be employed. For example, although the Emergency Service or Public Safety communication service has been considered herein, the techniques described may be applied to other types of system. In general, the system can distinguish two different types of users: one type with one or more service providers external to the cellular network (such as the Emergency Services as discussed above); and another with service provided by the cellular network. The system can additionally or alternatively distinguish between users with different service providers external to the cellular network. Whilst the situation where all of the UEs are within the cellular network coverage (or able to receive cellular network coverage) has been considered, the skilled person will understand that this can be extended to the case where the UEs are outside coverage, for example using a last known location within the coverage. Alternative network architectures may be employed, with the MME replaced by an alternative mobility management functionality, for instance. Similarly, the configuration of the core network may be changed.

1. A network entity of a cellular network, comprising:
a location determining interface, configured to receive geographical location information for one or more mobile terminals of the cellular network from one or both of: a core network part of the cellular network; and a network management part of the cellular network; and
action logic, configured to receive a request message identifying one or more geographical locations and to generate at least one alert message, causing an alert to be communicated to each of one or more mobile terminals in the identified one or more geographical locations, based on the received geographical location information.

2. The network entity of claim 1, wherein the at least one alert message causes the alert to be communicated to each of one or more mobile terminals in the identified one or more geographical locations at a time dependent on the received geographical location information.

3. The network entity of claim 1 or claim 2, wherein the action logic is further configured to determine whether the at least one alert message resulted in the alert being successfully communicated to each of one or more mobile terminals in the identified one or more geographical locations and to generate a re-transmit message causing the alert to be communicated again to one or more mobile terminals in the identified one or more geographical locations for which the alert was not successfully communicated.

4. The network entity of any preceding claim, wherein the location determining interface is further configured to detect a mobile terminal that was previously outside the identified one or more geographical locations and is now within the identified one or more geographical locations and wherein the action logic is further configured to cause the alert to be communicated to the detected mobile terminal that is now within the identified one or more geographical locations.

5. The network entity of any preceding claim, further comprising:
privacy logic, configured to detect any mobile terminals from the one or more mobile terminals in the identified one or more geographical locations that are on a privacy control list and to control the action logic not to cause an alert to any mobile terminals detected on the privacy control list.

6. The network entity of any preceding claim, wherein the alert to be communicated comprises a Short Messaging System, SMS, message.

7. The network entity of any preceding claim, wherein the location determining interface comprises an interface to at least one monitoring probe that is configured to monitor an interface between network entities of the core network part of the cellular network.

8. The network entity of claim 7, wherein the at least one monitoring probe is configured to monitor an interface between a Mobile Management Entity, MME, and Home Subscriber Server, HSS, of the core network part and/or between the MME and a Serving Gateway, SGW, or Packet Data Network Gateway, PGW of the core network part.

9. The network entity of any preceding claim, wherein the location determining interface comprises an interface with a Policy and Charging Rules Function, PCRF, of the cellular network.

10. The network entity of any preceding claim, wherein the location determining interface comprises an interface with an Operational Support System, OSS, or Network Management System, NMS of the cellular network.

11. The network entity of claim 10, wherein the interface with the OSS or NMS comprises:
request logic, configured to request the geographical location information for the one or more mobile terminals of the cellular network from the OSS or NMS; and
location logic, configured to receive the geographical location information for the one or more mobile terminals from the OSS or NMS and to determine further geographical location information for the one or more mobile terminals based on the received geographical location information.

12. The network entity of claim 10 or claim 11, wherein the interface with the OSS or NMS comprises an Application Programming Interface.

13. The network entity of any preceding claim, further comprising:
traffic control logic, configured to detect congestion on one or more interfaces of the cellular network and to enable throttling on the basis of the detection.

14. The network entity of any preceding claim, wherein the received geographical location information in respect of a mobile terminal comprises one or more of: at least one identifier for the mobile terminal; an identifier for a base station of the cellular network serving the mobile terminal; and a link quality between the mobile terminal and one or more base stations of the cellular network.

15. A method for user alerting in a cellular network, comprising:
receiving, at a network entity of the cellular network, geographical location information for one or more mobile terminals of the cellular network from one or both of: a core network part of the cellular network; and a network management part of the cellular network;
receiving a request message identifying one or more geographical locations; and
generating at least one alert message, causing an alert to be communicated to each of one or more mobile terminals in the identified one or more geographical locations, based on the received geographical location information.

16. A computer program, configured to perform the method of claim 15 when operated by a processor.
